(19) United States
(12) Patent Application Publication
(10) Pub. No.: US 2012/0117391 A1
(43) Pub. Date: May 10, 2012

(54) Method and System for Managing the Power Supply of a Component

(75) Inventors: David Jacquet, Vaulnaveys le Haut (FR); Fabrice Blisson, Grenoble (FR); Christophe Lecocq, Varces (FR); Pascal Urard, Theys (FR); Pascale Robert, Lumbin (FR)

(73) Assignee: STMicroelectronics SA, Montrouge (FR)

(21) Appl. No.: 13/243,661

(22) Filed: Sep. 23, 2011

(30) Foreign Application Priority Data
Nov. 10, 2010 (FR) 10 59480

(51) Int. Cl. G06F 1/26

(52) U.S. Cl. 713/300

(57) ABSTRACT

A method and system for managing the power supply of a component and of a memory cooperating with the component are disclosed. The component and the memory are powered with a first variable power supply source having a first power supply voltage level greater than a minimum operating voltage of the memory. When a voltage level of the first power supply source drops and reaches a threshold that is greater than or equal to the minimum operating voltage of the memory, the power supply of the memory is toggled to a second power supply source having a second voltage level that is greater than or equal to the minimum operating voltage of the memory.

### CROSS-REFERENCE TO RELATED APPLICATIONS

This application is a translation of and claims the priority benefit of French patent application number 10 59480, filed on Nov. 10, 2010, which is hereby incorporated by reference to the maximum extent allowable by law.

### TECHNICAL FIELD

The present invention relates generally to electronic components and, in particular embodiments, to a method and system for managing the power supply of a component.

### BACKGROUND

It is possible to power a component, for example a processor, and a memory cooperating with this component with one and the same power supply source. That being said, in the case of a processor, when the rate of the operations varies, it is possible for the power supply voltage provided to the processor to be made to vary, for example between 1.1 volt and 0.6 volt, as a function of this rate so as to optimize consumption. But the memory for its part requires a minimum operating voltage, for example 0.95 volts, below which it can no longer cooperate with the processor.

It is possible to power the processor and the memory with two distinct power supply sources. That being said, even if the two voltages are theoretically identical, their technological realization and the resistive inductive or capacitive paths, possibly different, between the sources and the component or the memory, may lead to a difference in voltage between the voltage actually applied to the component and that actually applied to the memory. This difference in voltage provided is problematic since the maximum operating frequencies of the component and of the memory are then not identical. The two components must then cooperate in a degraded mode (the slower of the two imposing the speed of the whole).

### SUMMARY

Embodiments of the invention relate to electronic components and especially to their power supply. It applies particularly, but not limitingly, to the power supply of an electronic component, for example a processor, and of a memory, for example a cache memory, cooperating with this component at one and the same operating frequency.

There is proposed according to one mode of implementation and embodiment, a power supply system and method which permits non-degraded normal operation, at one and the same frequency, of the component, for example a processor, and of the memory while being able to make the power supply voltage of the component vary so as to optimize consumption and continue to allow possible cooperation of the memory with the processor, or at the very least avoid loss of stored data.

According to one aspect, there is proposed a method for managing the power supply of a component, for example a processor or a microcontroller, and of a memory cooperating with the component. The component and the memory are powered with a first variable power supply source having a first power supply voltage level greater than an operating voltage of the memory. When the level of the voltage of the first power supply source drops and reaches a threshold greater than or equal to the minimum operating voltage of the memory, the power supply of the memory is toggled to a second power supply source having a second voltage level greater than or equal to the minimum operating voltage of the memory. The component can remain powered by the first source.

When the voltage provided by the first power supply source is for example greater than the minimum operating voltage of the memory a single same operating source is used. The component and the memory cooperate at the same speed in an optimized mode until the voltage provided by the first power supply source falls below the threshold. This voltage drop occurs especially when the activity of the component falls, so as to optimize consumption. When the voltage of the first power supply source falls below the threshold which may for example be equal to the operating voltage of the memory, then the memory is powered by a second power supply source.

It is thus possible to make the power supply voltage of the component vary throughout the interval comprising the voltages accepted by this component. There is no longer any bottom limit of this interval through the operating voltage of the memory. Consumption can thus be further optimized.

Moreover, this method allows very fast toggling (of the order of a few hundred nanoseconds) between the power supply voltage and the auxiliary voltage.

According to mode of implementation, the toggling comprises a transient powering of the memory with a transient power supply voltage having a third level greater than or equal to that of the retention voltage of the memory until the memory is actually powered by the second power supply source.

Indeed, when the power supply voltage of the memory is below the retention voltage, the memory loses the data stored therein. Now, in the course of the toggling of the power supply the power supply voltage of the memory may drop. The use of a transient power supply makes it possible to preserve in the course of the toggling a power supply voltage, across the terminals of the memory, greater than the retention voltage. Thus, there is no risk of the memory losing its data.

The transient power supply voltage may be delivered by a third power supply source having the third level, or else by the first power supply source. It is then not necessary to employ an additional third voltage source.

According to one mode of implementation, when the voltage level of the first source goes back above the threshold, the operations inverse to those performed during the voltage drop of the first source are performed so as to power the memory and the component with the first power supply source.

Thus, subsequent to the toggling to the same first power supply source the memory and the component can again cooperate at the same frequency with a voltage arising from the same source.

According to another aspect, there is proposed a system for managing the power supply of a component and of a memory cooperating with the component. A first variable power supply source is capable of having a first power supply voltage level greater than a minimum operating voltage of the memory and coupled to the component. A second power supply source has a second voltage level greater than or equal to the minimum operating voltage of the memory. A controllable switching circuit is connected between the first power supply source, the second power supply source and the memory. This circuit has a first configuration in which the first source and the memory are electrically linked and a second configuration in which the second source and the memory are electrically linked. A control circuit is configured so as to place the switching circuit in the first configuration when the voltage level of the first power supply is greater than a threshold greater than or equal to the minimum operating voltage of the memory and to place the switching circuit in the second configuration when the voltage level of the first power supply is less than or equal to the threshold.

According to one embodiment, the switching circuit comprise a first switch connected between the first power supply source and the memory and a second switch connected between the second power supply source and the memory. The first switch and the second switch are respectively in the on state and in the off state in the first configuration of the switching circuit and the first switch and the second switch are respectively in the off state and in the on state in the second configuration of the switching circuit.

According to one embodiment, the system furthermore comprises transient power supply circuit configured to deliver a transient power supply voltage having a third level greater than or equal to the retention voltage of the memory, and in which the switching circuit possess a third configuration in which they electrically link the transient power supply circuit to the memory. The control circuit is configured so as to place the switching circuit in the third configuration upon the toggling of the switching circuit from their first configuration to their second configuration and vice versa.

According to another embodiment, the control circuit is configured so as to place the switching circuit in the third configuration when the first switch and the second switch are off. The switching circuit comprises a third switch connected between the memory and transient power supply circuit. This third switch is on in the third configuration of the switching circuit.

According to another embodiment, the transient power supply circuit comprises a third power supply source having the third level, distinct from the first power supply source and from the second power supply source.

According to another embodiment, the transient power supply circuit comprise the first power supply source.

According to another embodiment, the first switch and the second switch each comprise at least one field-effect transistor, the resistance in the on state of the at least one transistor of the second switch being greater than the resistance in the on state of the at least one transistor of the first switch.

The use of a more significant resistance makes it possible to limit the short-circuit current when the third switch and the second switch are on.

According to another embodiment, the third switch comprises at least one field-effect transistor. The resistance in the on state of the at least one transistor of the third switch is greater than the resistance in the on state of the at least one transistor of the first switch and is also greater than the resistance in the on state of the at least one transistor of the second switch.

Thus when the third switch and the second switch are on, the short-circuit current is limited.

According to another embodiment, the substrates of the transistors of the first switch and of the second switch are linked together.

The transistors of the first switch and of the second switch can therefore be adjoining. The fabrication of the transistors occupies a less substantial surface area for one and the same number of transistors.

According to another embodiment, the substrates of the transistors of the first and second switches are linked to the second power supply source.

Thus, a flow of current through the diode of the transistor of the second switch via the transistor of the first switch to the first power supply is thus avoided in the case where the power supply voltage of the first power supply source is equal to 0.

According to another embodiment, the component comprises a processor.

### BRIEF DESCRIPTION OF THE DRAWINGS

Other advantages and characteristics of the invention will be apparent on examining the detailed description of wholly non-limiting modes of implementation and embodiments and the appended drawings in which:

FIGS. 1, 3, 4 and 6 illustrate embodiments of a power supply system according to the invention; and

FIGS. 2 and 5 illustrate a mode of implementation of a method for managing the power supply according to the invention.

### DETAILED DESCRIPTION OF ILLUSTRATIVE EMBODIMENTS

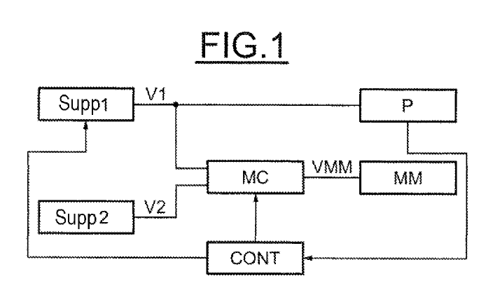

FIG. 1 illustrates an embodiment of a system according to the invention. This embodiment comprises a first variable power supply source Supp1 delivering a power supply voltage V1, a second power supply source Supp2 delivering a power supply voltage V2, switching circuit MC, a component P for example a processor, and a memory MM powered by a voltage VMM across its terminals.

Switching circuit MC makes it possible to power the memory with a voltage equal to V1 or V2 as a function of their configuration. The switching circuit MC is controllable by control circuit CONT. The level of the voltage V1 depends on the activity of the processor. The first power supply source Supp1 is also driven in this example by the control circuit CONT so as to deliver a level V1 corresponding to the activity of the processor. The control circuit configure the switching circuit MC as a function of the level of the voltage V1.

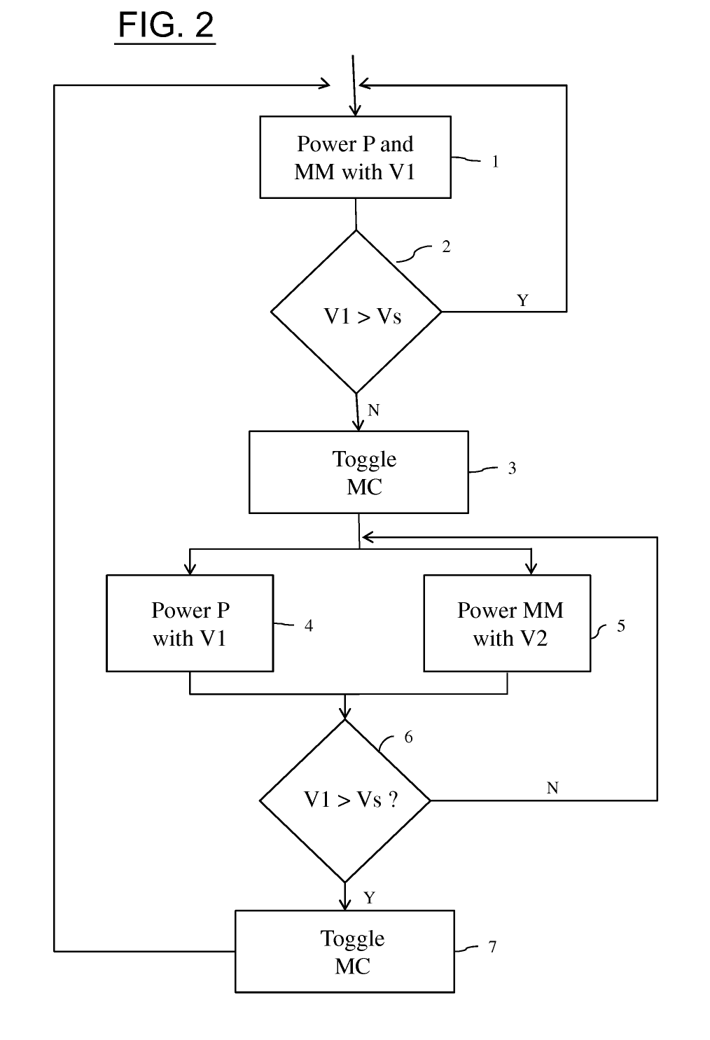

FIG. 2 illustrates a method of powering a component P and of a memory MM according to an embodiment of the invention.

In a step 1 the component P and the memory MM are powered by a first power supply source Supp1.

In a step 2 a test is carried out to check whether the power supply voltage V1 of the first power supply source Supp1 is greater than a threshold voltage Vs. This threshold voltage is greater than or equal to, for example equal to, a minimum operating voltage of the memory.

When the power supply voltage of the first power supply source Supp1 drops, reaching the threshold voltage Vs, then we go to a step 3. Otherwise the method is continued by returning to the first step 1. In the course of step 3 the power supply of the memory MM is toggled to the second power supply source Supp2.

Subsequent to this toggling, the powering of the component P with the first power supply source Supp1 is continued in a step 4 and the memory MM is powered with the second power supply source Supp2 in a step 5. It should be noted here that the voltage V1 may continue to drop. But even in this case, the processor and the memory can continue to cooperate at the rate imposed by the processor.

In a step 6 a test is carried out to check whether the power supply voltage of the first power supply Supp1 is greater than the threshold voltage Vs. If it is not greater the method is continued by returning to steps 4 and 5.

When the power supply voltage of the first power supply Supp1 rises and becomes greater than the threshold voltage Vs, then we go to a step 7, in which the power supply of the memory MM is toggled to the first power supply source Supp1.

Thus it is possible to return to step 1 in the course of which the component P and the memory MM are powered by the first power supply source Supp1.

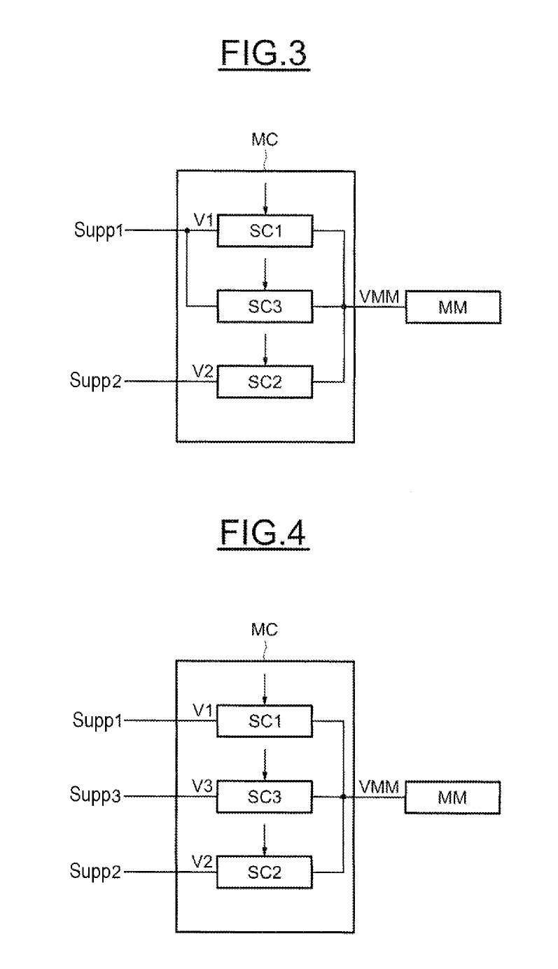

FIG. 3 illustrates in detail the switching circuit MC according to a first embodiment. The switching circuit MC comprise two switches SC1 and SC2 respectively connected between the memory and the first power supply source Supp1 and the second power supply source Supp2. The on or off state of the switches SC1 and SC2 is driven by control circuit CONT. The switching circuit possesses a first configuration in which it electrically links the first source Supp1 and the memory MM and a second configuration in which it electrically links the second source Supp2 and the memory MM. In the first configuration the first switch SC1 and the second switch SC2 are on and off, respectively. In the second configuration the first switch SC1 and the second switch SC2 are off and on, respectively.

Upon the change of configuration the switch SC1 and SC2 cannot simultaneously be on, since a short circuit would ensue.

The example hereinbelow makes it possible to illustrate the fact that the two switches cannot be controllable so as to be simultaneously on. In this example, the following constraints and assumptions are considered:
an acceptable maximum resistive drop in the switches SC1 and SC2 is equal to 5 mV,
a maximum current of 50 mA is consumed by the memory when it is linked electrically to the first power supply source, that is to say when it cooperates at the same speed as the component (P) in an optimized mode of operation. The switching circuit MC is then in the first configuration in which the switch SC1 is on and the switch SC2 is off,
a current of 12.5 mA is consumed by the memory when it cooperates with the component P whose activity has fallen in such a way that the voltage V1 of the power supply Supp1 is less than the threshold voltage. The switching circuit MC is then in the second configuration in which the switch SC1 is off and the switch SC2 is on,
the threshold voltage Vs is chosen in such a way that the maximum difference between the voltage V1 and the voltage V2 at the moment of the transition is less than 200 mV. For example if V2 is equal to a minimum operating voltage of the memory VFON=0.95 volt then Vs must be such that the absolute value of (VFON−Vs) is less than 100 mV.

A resistance in the on state of the switch SC1 equal to 5 mV/50 mA=0.1 Ohm and of the switch SC2 equal to 5 mV/12.5 mA=0.4 Ohm is thus obtained. With these values if the two switches SC1 and SC2 are simultaneously in the on state then the short-circuit current is: 0.2/(0.4+0.1)=400 mA. This is a current that would cause an unacceptable plunge in the voltages of the power supplies Supp1 or Supp2. It is therefore necessary that the switches are controlled so as to be non-covering. A person skilled in the art will know to adapt the architecture of the control circuit CONT, for example a logic circuit, so as to comply with this constraint.

In addition, the two switches SC1 and SC2 should not be simultaneously off since there would then be a risk of the voltage VMM across the terminals of the memory MM becoming less than a retention voltage VRET below which the memory loses the data stored therein.

One option is to adapt the control of the switching circuit to avoid this situation. Another particularly simple solution provides that the switching circuit MC comprise a third switch SC3. This switch SC3 is connected, for example, between the first power supply source Supp1 and the memory MM and will convey a voltage greater than the retention voltage VRET across the terminals of the memory when the two switches SC1 and SC2 are off. In the course of its activation, the switch SC3 will be on simultaneously with the first and/or the second switch, but given that the current consumed by the memory in the course of the togglings is very low, the resistance of the third switch SC3 can be chosen to be more substantial. This makes it possible to decrease the short-circuit current.

By way of example, in the course of the toggling, the memory is no longer in operation and consumes a leakage current of about 4 mA at 125° C.

A more substantial resistive drop may be accepted in the third switch SC3. There is indeed no constraint relating to operation in cooperation with the component P. For example, a resistive drop of 100 mV can be accepted.

A resistance in the on state for the switch SC3 of 100 mV/4 mA=25 Ohm is obtained.

If the switches SC3 and SC2 are simultaneously in the on state then the short-circuit current is: 0.2/(25+0.4)=7.9 mA. If the switches SC1 and SC3 are on, then there is no short circuit since they are linked to the same potential (voltage V1). Thus, the short-circuit current is greatly decreased and does not cause any plunge in the power supply voltages.

FIG. 4 illustrates another embodiment in which the retention voltage VRET, or a voltage greater than this retention voltage, is provided by a third power supply source Supp3. Assuming a voltage difference between the third source Supp3 and the minimum operating voltage of the memory VFON of less than 0.2 Volt, the calculations stated above are still valid. An additional case of short circuit arises when the switches SC1 and SC3 are covering, the short-circuit current is then equal to 0.2/(25+0.1)=7.97 mA. This is a current which is nearly identical to the case where the two switches SC2 and SC3 are on and there is no risk of destruction.

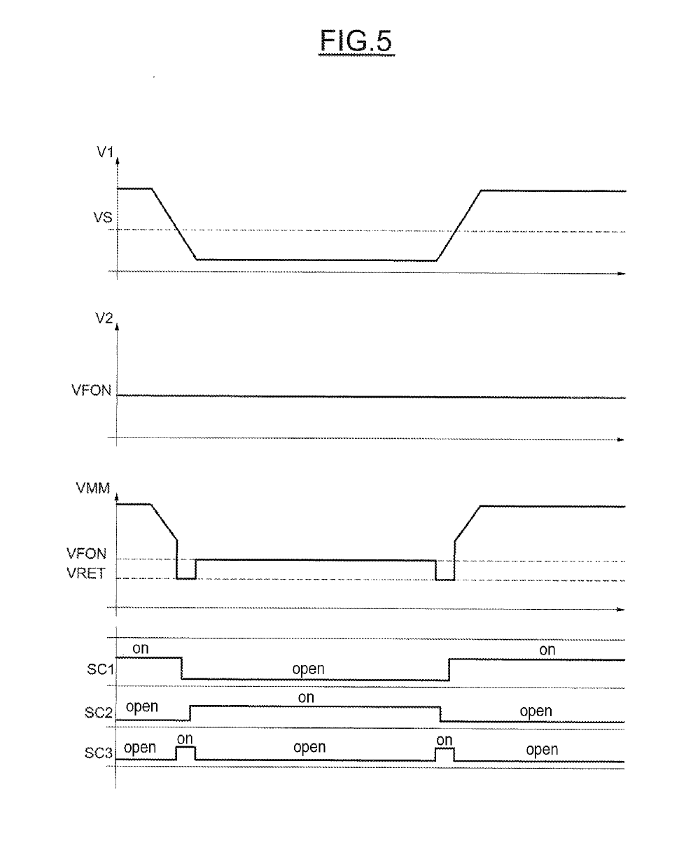

FIG. 5 illustrates examples of evolution of the voltage V1 of the first power supply source, of the voltage V2 of the second power supply source, of the voltage VMM across the terminals of the memory, and of the positions of the three switches SC1, SC2, SC3.

In this example, the voltage of the first power supply source varies from a maximum value for example 1.1 volt to a lower value for example 0.6 volt and then goes back to its maximum value. In the course of this drop and of this climb in voltage, the voltage V1 passes through the threshold value Vs twice. This value Vs is greater than the minimum operating voltage of the memory VFON. For example, the minimum operating voltage VFON of the memory may be 0.95 volt. The toggling (steps 3 and 7 in FIG. 2) intervene in the course of the overshooting or undershooting of the threshold Vs by the voltage V1.

In a first stage, the voltage of the first power supply source has a maximum value, for example 1.1 volt. In the switching circuit MC, the first switch SC1 is on, the second switch is off and the third switch SC3 is off. The voltage VMM across the terminals of the memory MM is then equal (to within the resistive loss by the switch SC1 in its on state) to the voltage V1 of the first power supply source.

Next, during the drop in the first power supply voltage V1, the power supply toggling is carried out by the switching circuit MC when voltage V1 reaches the threshold voltage Vs. This toggling comprises three stages. In a first stage, the first switch SC1 remains on, the switch SC3 turns on, and the second switch SC2 is off. In a second stage, only the switch SC3 is on. In a third stage, the switches SC3 and SC2 are on while first switch SC1 remains off. Principally, in the course of this toggling the first and second switches SC1 and SC2 are off and the third switch SC3 is on. The voltage VMM across the terminals of the memory MM is equal to the retention voltage VRET provided by a third power supply source.

Next, on completion of the toggling, the switch SC2 is on and the switches SC1 and SC3 are off. The voltage VMM across the terminals of the memory VMM is then equal to the voltage V2 of the second power supply source (to within the resistive loss by the switch SC2 in its on state), that is, to the minimum operating voltage VFON.

When the voltage V1 goes back above the threshold voltage Vs, another toggling is carried out. This toggling comprises three stages. In a first stage, the second switch SC2 remains on, the switch SC3 turns on, and the first switch remains off. In a second stage, only the switch SC3 is on. In a third stage, the switches SC3 and SC1 are on while the second switch SC2 is off. Principally, in the course of this toggling the first and second switches SC1 and SC2 are off and the third switch SC3 (FIG. 5) is on. The voltage VMM across the terminals of the memory MM is equal to the retention voltage VRET.

Next, on completion of the toggling the switch SC1 is on and the switches SC2 and SC3 are off. Thus the situation is the initial one.

The duration of each of the two toggling steps is, for example, 100 ns. This duration is very small since it represents only a few hundred instructions of a processor in the case where the component P is a processor operating at several GHz.

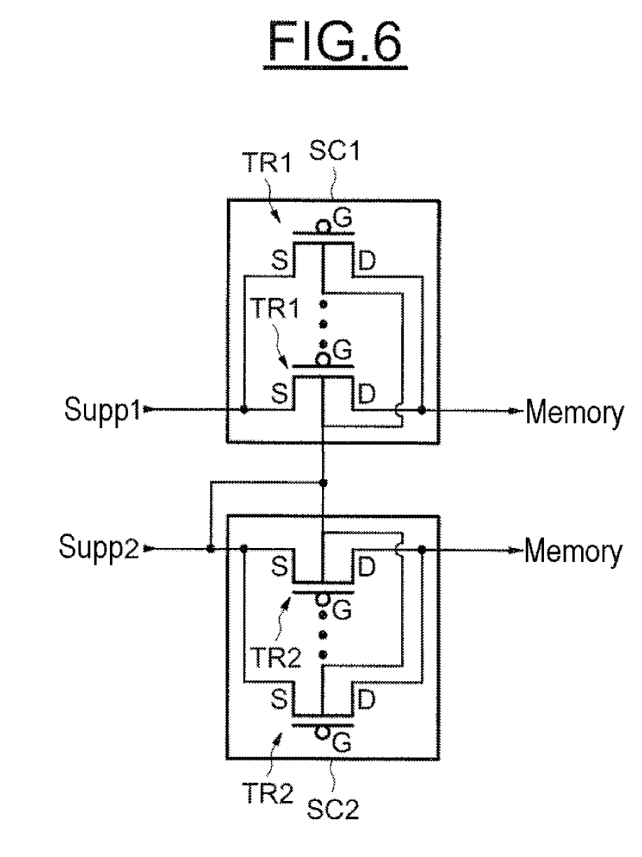

FIG. 6 illustrates an embodiment of the switches SC1 and SC2. Each switch SC1 (SC2) in this example comprises P-channel field-effect transistors TR1 (TR2) coupled in parallel with each source linked to the power supply side, each drain coupled to the memory side and the gates linked to the control circuit CONT. The substrates of the transistors TR1 of the first switch SC1 are linked to the substrates of the transistors TR2 of the second switch SC2. Although it is possible to link the substrates to Supp1, it is preferable, especially in order to avoid a flow of current through the diode of the transistor TR2 of the second switch towards the common substrate, and therefore towards the first power supply when the voltage V1 falls to 0 Volt, for the substrates to be linked to the power supply Supp2.

What is claimed is:

1. A method for managing the supply of power to a component and to a memory cooperating with the component, the method comprising:
powering the component and the memory with a first variable power supply source having a first power supply voltage level greater than a minimum operating voltage of the memory; and
when a voltage level of the first power supply source drops and reaches a threshold that is greater than or equal to the minimum operating voltage of the memory, toggling the power supply of the memory to a second power supply source having a second voltage level that is greater than or equal to the minimum operating voltage of the memory, wherein the component remains powered by the first source.

2. The method according to claim 1, wherein toggling the power supply comprises powering the memory with a transient power supply voltage having a third level greater than or equal to that of the minimum operating voltage of the memory until the memory is actually powered by the second power supply source.

3. The method according to claim 2, wherein the transient power supply voltage is delivered by a third power supply source having the third level.

4. The method according to claim 2, wherein the transient power supply voltage is delivered by the first power supply source.

5. The method according to claim 1, further comprising toggling the power supply of the memory to the first power supply source when the voltage level of the first source goes back above the threshold after which the memory and the component are powered with the first power supply source.

6. A power supply system for a component and a memory cooperating with the component, the system comprising:
a first variable power supply source configured to supply a first power supply voltage level that varies between a maximum value that is greater than a minimum operating voltage of the memory and a minimum value that is less than the minimum operating voltage of the memory;
a second power supply source configured to supply a second power supply voltage level that is greater than or equal to the minimum operating voltage of the memory;
a controllable switching circuit coupled to the first power supply source, the second power supply source and to a memory connection node, the switching circuit having a first configuration wherein the first source is electrically coupled to the memory connection node and a second configuration wherein the second source is electrically coupled to the memory connection node; and
a control circuit configured to place the switching circuit in the first configuration when the voltage level of the first power supply is greater than a threshold that is greater than or equal to the minimum operating voltage of the memory and to place the switching circuit in the second configuration when the voltage level of the first power supply is less than or equal to the threshold.

7. The system according to claim 6, wherein the switching circuit comprises a first switch coupled between the first power supply source and the memory connection node and a second switch connected between the second power supply source and the memory connection node.

8. The system according to claim 7, wherein the first switch is in an on state and the second switch is in an off state in the first configuration of the switching circuit and wherein the first switch is in an off state and the second switch is in an on state in the second configuration of the switching circuit.

9. The system according to claim 7, further comprising a transient power supply source configured to supply a transient power supply voltage having a third level that is greater than or equal to the minimum operating voltage of the memory, wherein the switching circuit further comprises a third switch coupled between the transient power supply source and the memory connection node.

10. The system according to claim 9, wherein the control circuit is configured to place the switching circuit in a third configuration when the first switch and the second switch are off, wherein the transient power supply source is electrically coupled to the memory connection node in the third configuration.

11. The system according to claim 9, wherein the first switch, the second switch and the third switch each comprise at least one field-effect transistor, a resistance in the on state of the at least one transistor of the second switch being greater than a resistance in the on state of the at least one transistor of the first switch and a resistance in the on state of the at least one transistor of the third switch being greater than both the resistance in the on state of the at least one transistor of the first switch and the resistance in the on state of the at least one transistor of the second switch.

12. The system according to claim 7, wherein the first switch and the second switch each comprise at least one field-effect transistor, a resistance in the on state of the at least one transistor of the second switch being greater than a resistance in the on state of the at least one transistor of the first switch.

13. The system according to claim 12, wherein substrates of the transistors of the first switch and of the second switch are linked together.

14. The system according to claim 13, wherein the substrates of the transistors of the first and second switches are linked to the second power supply source.

15. The system according to claim 6, further comprising a transient power supply source configured to supply a transient power supply voltage having a third level that is greater than or equal to the minimum operating voltage of the memory, wherein the switching circuit has a third configuration wherein the transient power supply source is electrically coupled to the memory connection node and wherein the control circuit is configured to place the switching circuit in the third configuration upon toggling the switching circuit from the first configuration to the second configuration and vice versa.

16. The system according to claim 15, wherein the transient power supply source comprises a third power supply source having the third level, the third power supply source distinct from the first power supply source and from the second power supply source.

17. The system according to claim 15, wherein the transient power supply source comprises the first power supply source.

18. A power supply system for a component and a memory (MM) cooperating with the component, the system comprising:
first power supply means for supplying a first power supply voltage level that varies between a maximum value that is greater than a minimum operating voltage of the memory and a minimum value that is less than the minimum operating voltage of the memory;
second power supply means for supplying a second power supply voltage level that is greater than or equal to the minimum operating voltage of the memory;
switching means for electrically coupling the first power supply means to an memory connection node in a first configuration and for electrically coupling the second power supply means to the memory connection node in a second configuration; and
control means for causing the switching means to be placed in the first configuration when the voltage level of the first power supply is greater than a threshold that is greater than or equal to the minimum operating voltage of the memory and for causing the switching means to be placed in the second configuration when the voltage level of the first power supply is less than or equal to the threshold.

19. The system according to claim 18, further comprising transient power supply means for supplying a transient power supply voltage having a third level that is greater than or equal to the minimum operating voltage of the memory, the switching means for electrically coupling the transient power supply means to the memory connection node in a third configuration and the control means for causing the switching means to be placed in the third configuration during a transition time when switching between the first configuration and the second configuration.

20. An electronic system comprising:
a component;
a memory configured to cooperate with the component;
a first variable power supply source configured to supply a first power supply voltage level that varies between a maximum value that is greater than a minimum operating voltage of the memory and a minimum value that is less than the minimum operating voltage of the memory, the first power supply source coupled to the component;
a second power supply source configured to supply a second power supply voltage level that is greater than or equal to the minimum operating voltage of the memory;
a controllable switching circuit coupled to the first power supply source, the second power supply source and to a memory connection node, the switching circuit having a first configuration wherein the first source is electrically coupled to the memory and a second configuration wherein the second source is electrically coupled to the memory; and
a control circuit configured to place the switching circuit in the first configuration when the voltage level of the first power supply is greater than a threshold that is greater than or equal to the minimum operating voltage of the memory and to place the switching circuit in the second configuration when the voltage level of the first power supply is less than or equal to the threshold.

21. The system according to claim 20, wherein the component comprises a processor.

22. The system according to claim 21, wherein the component comprises a microprocessor.

23. The system according to claim 20, wherein the switching circuit comprises a first switch coupled between the first power supply source and the memory and a second switch connected between the second power supply source and the memory.

24. The system according to claim 23, further comprising a transient power supply source configured to supply a transient power supply voltage having a third level that is greater than or equal to the minimum operating voltage of the memory, wherein the switching circuit further comprises a third switch coupled between the transient power supply source and the memory.

25. The system according to claim 24, wherein the first switch, the second switch and the third switch each comprise at least one field-effect transistor, a resistance in the on state of the at least one transistor of the second switch being greater than a resistance in the on state of the at least one transistor of the first switch and a resistance in the on state of the at least one transistor of the third switch being greater than both the resistance in the on state of the at least one transistor of the first switch and the resistance in the on state of the at least one transistor of the second switch.

26. The system according to claim 20, further comprising a transient power supply source configured to supply a transient power supply voltage having a third level that is greater than or equal to the minimum operating voltage of the memory, wherein the switching circuit has a third configuration wherein the transient power supply source is electrically coupled to the memory and wherein the control circuit is configured to place the switching circuit in the third configuration upon toggling the switching circuit from the first configuration to the second configuration and vice versa.
